(19) United States
(12) Patent Application Publication
(10) Pub. No.: US 2011/0151974 A1
(43) Pub. Date: Jun. 23, 2011

(54) GESTURE STYLE RECOGNITION AND REWARD

(75) Inventor: Joel B. Deaguero, Snohomish, WA (US)

(73) Assignee: MICROSOFT CORPORATION, Redmond, WA (US)

(21) Appl. No.: 12/642,589

(22) Filed: Dec. 18, 2009

(51) Int. Cl. A63F 9/24; G06K 9/00; G06K 9/68; A63F 13/00; H04N 7/18

(52) U.S. Cl. 463/37; 382/181; 382/218; 463/43; 463/30; 348/77; 348/E07.085

(57) ABSTRACT

Systems, methods and computer readable media are disclosed for determining whether a given gesture was performed with a particular style. This style information may then be used to personalize a gaming or multimedia experience, rewarding users for their individual style.

### BACKGROUND

In the past, computing applications such as computer games and multimedia applications used controls to allow users to manipulate game characters or other aspects of an application. Typically such controls are input using, for example, controllers, remotes, keyboards, mice, or the like. More recently, computer games and multimedia applications have begun employing cameras and software gesture recognition engines to provide a human computer interface (“HCI”). With HCI, user gestures are detected, interpreted and used to control game characters or other aspects of an application.

In conventional gaming and multimedia applications, HCI is used to measure on a pass/fail basis whether or not a user has adequately performed a given gesture in response to a prompt or scenario. By contrast, conventional systems do not measure how the gesture was performed. As long as the HCI system determines the requested gesture is performed to a threshold level, the user is rewarded pursuant to the game/application metric. However, a user's movements may provide a wealth of information above and beyond simply whether or not a requested gesture was performed to a threshold level. Different users perform gestures in different ways. Some may perform a given gesture more gracefully than others. Some may try harder and exert more effort in performing a gesture than others. Conventional HCI systems do not take these parameters into account when measuring the pass/fail status of a given gesture.

### SUMMARY

Disclosed herein are systems and methods for determining whether a given gesture was performed with a particular style. This additional information may then be used to personalize a gaming or multimedia experience, rewarding users for their individual style. In one embodiment, the present technology relates to a gaming system including an image capture device for capturing data relating to motion of a user, a computing environment for receiving image data from the capture device and for hosting a gaming application, and an audiovisual device, coupled to the computing environment.

The computing environment includes a first order gesture recognition engine for receiving data relating to the motion of a user, and determining on a pass/fail basis whether the motion of the user qualifies as a predefined gesture. The computing environment further includes a second order gesture recognition engine for receiving the data or information derived from the data. The second order gesture recognition engine determines, in addition to a threshold determination of whether the motion of the user qualifies as a predefined gesture, whether the motion of the user includes a stylistic attribute which qualifies as a predefined style associated with the user motion. The computing environment further stores a set of rules that are used by the second order gesture recognition engine. The set of stored rules include definitions of when a predefined set of user motions is to be interpreted as a predefined style.

The audiovisual device presents a graphical representation of the user and the user's motion based on information received from the computing environment. The graphical representation of the user or user's surrounding may be enhanced by showing a user's motion with graphics representing a style determined to exist by the second order gesture recognition engine.

### BRIEF DESCRIPTION OF THE DRAWINGS

FIGS. 1A and 1B illustrate an example embodiment of a target recognition, analysis, and tracking system with a user playing a game.

FIG. 2 illustrates an example embodiment of a capture device that may be used in a target recognition, analysis, and tracking system.

FIG. 3A illustrates an example embodiment of a computing environment that may be used to interpret one or more gestures in a target recognition, analysis, and tracking system.

FIG. 3B illustrates another example embodiment of a computing environment that may be used to interpret one or more gestures in a target recognition, analysis, and tracking system.

FIG. 4A illustrates a skeletal mapping of a user that has been generated from the target recognition, analysis, and tracking system of FIG. 2.

FIG. 4B illustrates further details of the gesture recognizer architecture shown in FIG. 2.

FIGS. 5A and 5B illustrate how gesture filters may be stacked to create more complex gesture filters.

FIGS. 6A, 6B, 6C, 6D, and 6E illustrate an example gesture that a user 502 may make to signal for a “fair catch” in a football video game.

FIGS. 7A, 7B, 7C, 7D, and 7E illustrate the example “fair catch” gesture of FIGS. 6A, 6B, 6C, 6D, and 6E as each frame of image data has been parsed to produce a skeletal map of the user.

FIG. 8 is a block diagram of the gesture recognizer engine including the first and second order gesture recognition engines.

FIG. 9 is a block diagram showing the second order gesture recognition engine.

FIG. 10 is a flowchart showing the operation of the second order gesture recognition engine.

FIG. 11 is a flowchart showing the detailed steps for determining whether a given movement satisfies a stored rule relating to styles as detected by the second order gesture recognition engine.

### DETAILED DESCRIPTION

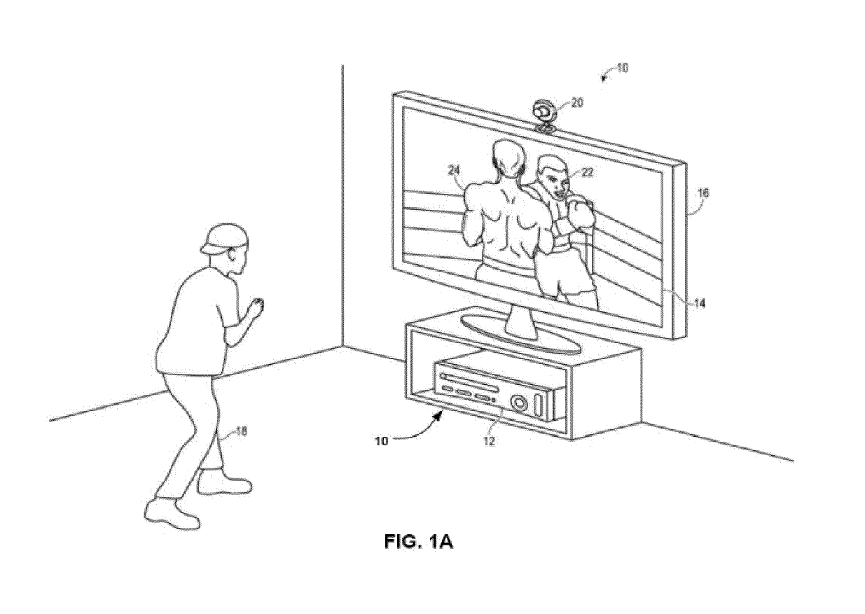

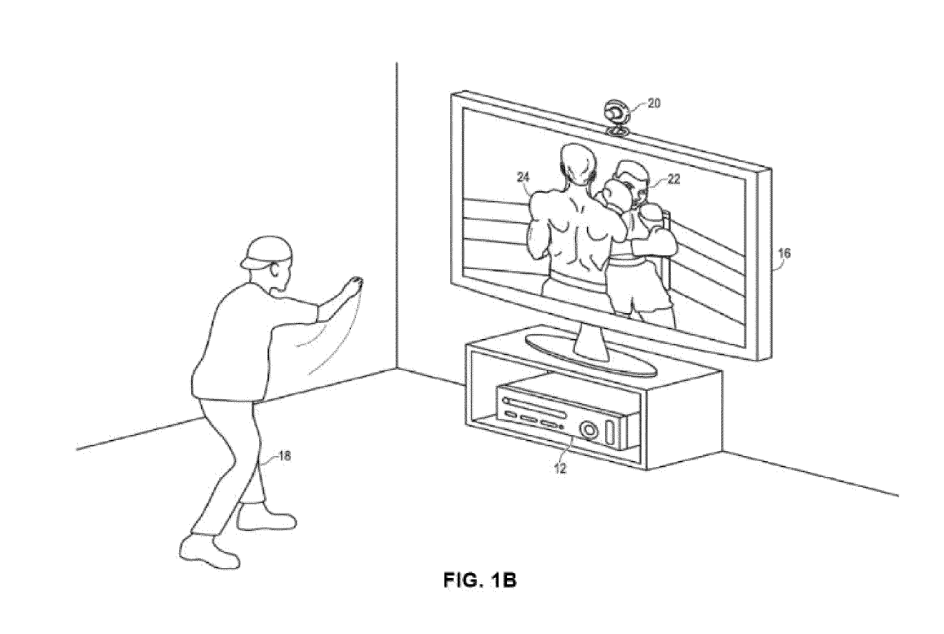

Embodiments of the present technology will now be described with reference to FIGS. 1-11, which in general relate to a system where user gestures control an application executing on a computing environment such as a game console, a computer, or the like. In embodiments, the present system detects and interprets user movements in two processes. A first process is performed by a first order gesture recognition engine which identifies particular gestures made by the user. In embodiments, once a gesture has been recognized by the first order recognition engine, a second order gesture recognition engine may then perform a second process of determining if any conclusions can be reached as to the qualitative aspects of the detected gesture. These qualitative aspects are at times referred to herein as the gesture style. The gesture style may relate to a variety of attributes of the gesture, including for example:
Grace with which a gesture is performed;
Effort exerted by the user in performing the gesture;
Body control of the user in performing the gesture;
Precision of the user's movement in performing the gesture;
Efficiency of the user's movement in performing the gesture;
Flair or dramatic movement by the user in performing the gesture;
A measure of how slow and steady the gesture was;
A measure of how nonchalant and relaxed the gesture was.
   Other styles are contemplated. The hardware and software, including the first and second order gesture recognition engines for performing the present technology, are discussed in greater detail below.

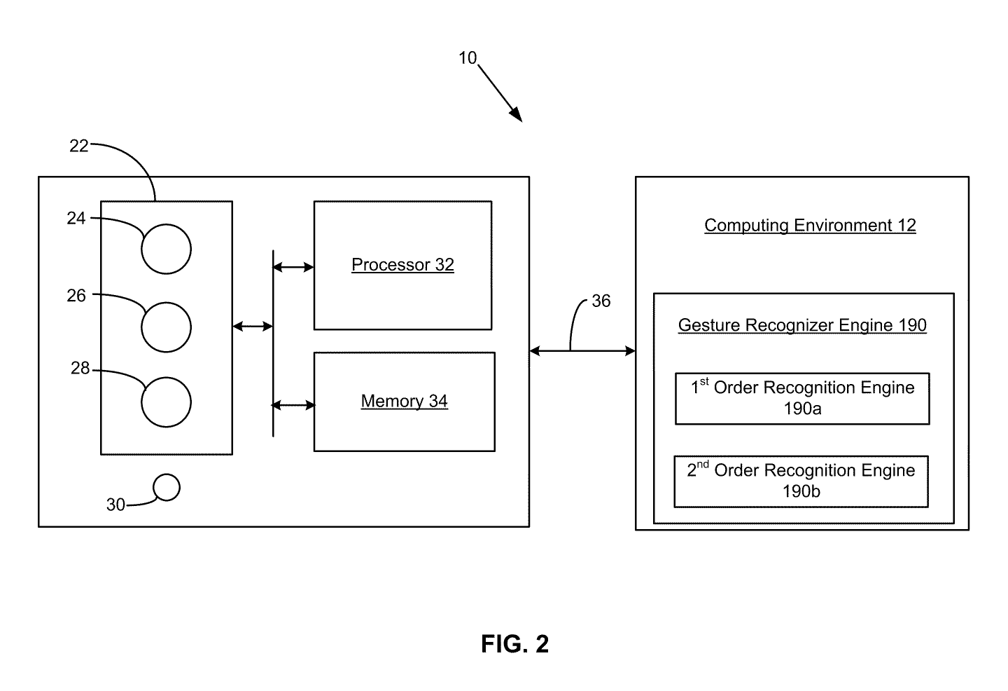

Referring initially to FIGS. 1A-2, the hardware for implementing the present technology includes a target recognition, analysis, and tracking system 10 which may be used to recognize, analyze, and/or track a human target such as the user 18. Embodiments of the target recognition, analysis, and tracking system 10 include a computing environment 12 for executing a gaming or other application, and an audiovisual device 16 for providing audio and visual representations from the gaming or other application. The system 10 further includes a capture device 20 for detecting gestures of a user captured by the device 20, which the computing environment receives and uses to control the gaming or other application. Each of these components is explained in greater detail below.

As shown in FIGS. 1A and 1B, in an example embodiment, the application executing on the computing environment 12 may be a boxing game that the user 18 may be playing. For example, the computing environment 12 may use the audiovisual device 16 to provide a visual representation of a boxing opponent 22 to the user 18. The computing environment 12 may also use the audiovisual device 16 to provide a visual representation of a player avatar 24 that the user 18 may control with his or her movements. For example, as shown in FIG. 1B, the user 18 may throw a punch in physical space to cause the player avatar 24 to throw a punch in game space. Thus, according to an example embodiment, the computer environment 12 and the capture device 20 of the target recognition, analysis, and tracking system 10 may be used to recognize and analyze the punch of the user 18 in physical space such that the punch may be interpreted as a game control of the player avatar 24 in game space.

Other movements by the user 18 may also be interpreted as other controls or actions, such as controls to bob, weave, shuffle, block, jab, or throw a variety of different power punches. Moreover, as explained below, once the system determines that a gesture is one of a punch, bob, weave, shuffle, block, etc., additional qualitative aspects of the gesture in physical space may be determined These qualitative aspects can affect how the gesture (or other audio or visual features) are shown in the game space as explained hereinafter.

In example embodiments, the human target such as the user 18 may have an object. In such embodiments, the user of an electronic game may be holding the object such that the motions of the player and the object may be used to adjust and/or control parameters of the game. For example, the motion of a player holding a racket may be tracked and utilized for controlling an on-screen racket in an electronic sports game. In another example embodiment, the motion of a player holding an object may be tracked and utilized for controlling an on-screen weapon in an electronic combat game.

FIG. 2 illustrates an example embodiment of the capture device 20 that may be used in the target recognition, analysis, and tracking system 10. Further details relating to a capture device for use with the present technology are set forth in copending patent application No. ______, entitled “GESTURE TOOL,” and copending patent application No. ______, entitled “STANDARD GESTURES,” each of which applications is incorporated herein by reference in its entirety. However, in an example embodiment, the capture device 20 may be configured to capture video having a depth image that may include depth values via any suitable technique including, for example, time-of-flight, structured light, stereo image, or the like. According to one embodiment, the capture device 20 may organize the calculated depth information into “Z layers,” or layers that may be perpendicular to a Z axis extending from the depth camera along its line of sight.

As shown in FIG. 2, the capture device 20 may include an image camera component 22. According to an example embodiment, the image camera component 22 may be a depth camera that may capture the depth image of a scene. The depth image may include a two-dimensional (2-D) pixel area of the captured scene where each pixel in the 2-D pixel area may represent a length in, for example, centimeters, millimeters, or the like of an object in the captured scene from the camera.

As shown in FIG. 2, according to an example embodiment, the image camera component 22 may include an IR light component 24, a three-dimensional (3-D) camera 26, and an RGB camera 28 that may be used to capture the depth image of a scene. For example, in time-of-flight analysis, the IR light component 24 of the capture device 20 may emit an infrared light onto the scene and may then use sensors (not shown) to detect the backscattered light from the surface of one or more targets and objects in the scene using, for example, the 3-D camera 26 and/or the RGB camera 28.

According to another embodiment, the capture device 20 may include two or more physically separated cameras that may view a scene from different angles, to obtain visual stereo data that may be resolved to generate depth information.

The capture device 20 may further include a microphone 30. The microphone 30 may include a transducer or sensor that may receive and convert sound into an electrical signal. According to one embodiment, the microphone 30 may be used to reduce feedback between the capture device 20 and the computing environment 12 in the target recognition, analysis, and tracking system 10. Additionally, the microphone 30 may be used to receive audio signals that may also be provided by the user to control applications such as game applications, non-game applications, or the like that may be executed by the computing environment 12.

In an example embodiment, the capture device 20 may further include a processor 32 that may be in operative communication with the image camera component 22. The processor 32 may include a standardized processor, a specialized processor, a microprocessor, or the like that may execute instructions that may include instructions for receiving the depth image, determining whether a suitable target may be included in the depth image, converting the suitable target into a skeletal representation or model of the target, or any other suitable instruction.

The capture device 20 may further include a memory component 34 that may store the instructions that may be executed by the processor 32, images or frames of images captured by the 3-D camera or RGB camera, or any other suitable information, images, or the like. According to an example embodiment, the memory component 34 may include random access memory (RAM), read only memory (ROM), cache, Flash memory, a hard disk, or any other suitable storage component. As shown in FIG. 2, in one embodiment, the memory component 34 may be a separate component in communication with the image capture component 22 and the processor 32. According to another embodiment, the memory component 34 may be integrated into the processor 32 and/or the image capture component 22.

As shown in FIG. 2, the capture device 20 may be in communication with the computing environment 12 via a communication link 36. The communication link 36 may be a wired connection including, for example, a USB connection, a Firewire connection, an Ethernet cable connection, or the like and/or a wireless connection such as a wireless 802.11b, g, a, or n connection. According to one embodiment, the computing environment 12 may provide a clock to the capture device 20 that may be used to determine when to capture, for example, a scene via the communication link 36.

Additionally, the capture device 20 may provide the depth information and images captured by, for example, the 3-D camera 26 and/or the RGB camera 28, and a skeletal model that may be generated by the capture device 20 to the computing environment 12 via the communication link 36. A variety of known techniques exist for determining whether a target or object detected by capture device 20 corresponds to a human target. Skeletal mapping techniques may then be used to determine various spots on that user's skeleton, joints of the hands, wrists, elbows, knees, nose, ankles, shoulders, and where the pelvis meets the spine. Other techniques include transforming the image into a body model representation of the person and transforming the image into a mesh model representation of the person.

The skeletal model may then be provided to the computing environment 12 such that the computing environment may track the skeletal model and render an avatar associated with the skeletal model. The computing environment may further determine which controls to perform in an application executing on the computer environment based on, for example, gestures and gesture styles of the user that have been recognized from the skeletal model. For example, as shown, in FIG. 2, the computing environment 12 may include a gesture recognizer engine 190. The gesture recognizer engine 190 is explained hereinafter, but may in general include a collection of gesture filters, each comprising information concerning a gesture that may be performed by the skeletal model (as the user moves). The data captured by the cameras 26, 28 and device 20 in the form of the skeletal model and movements associated with it may be compared to the gesture filters in the gesture recognizer engine 190 to identify when a user (as represented by the skeletal model) has performed one or more gestures. Those gestures may be associated with various controls of an application. Thus, the computing environment 12 may use the gesture recognizer engine 190 to interpret movements of the skeletal model and to control an application based on the movements.

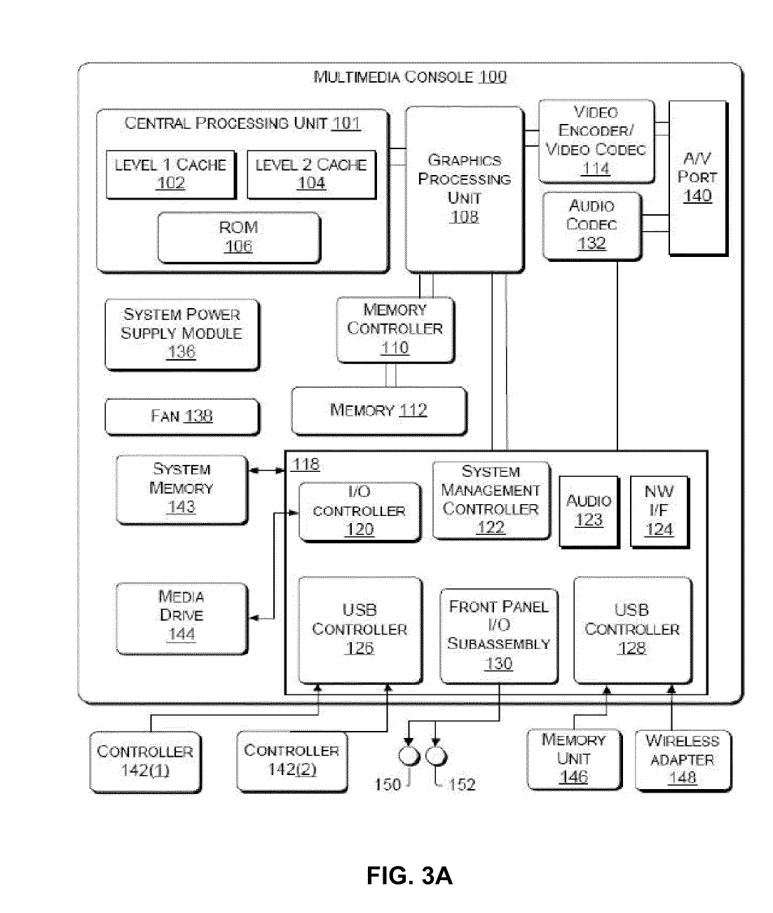

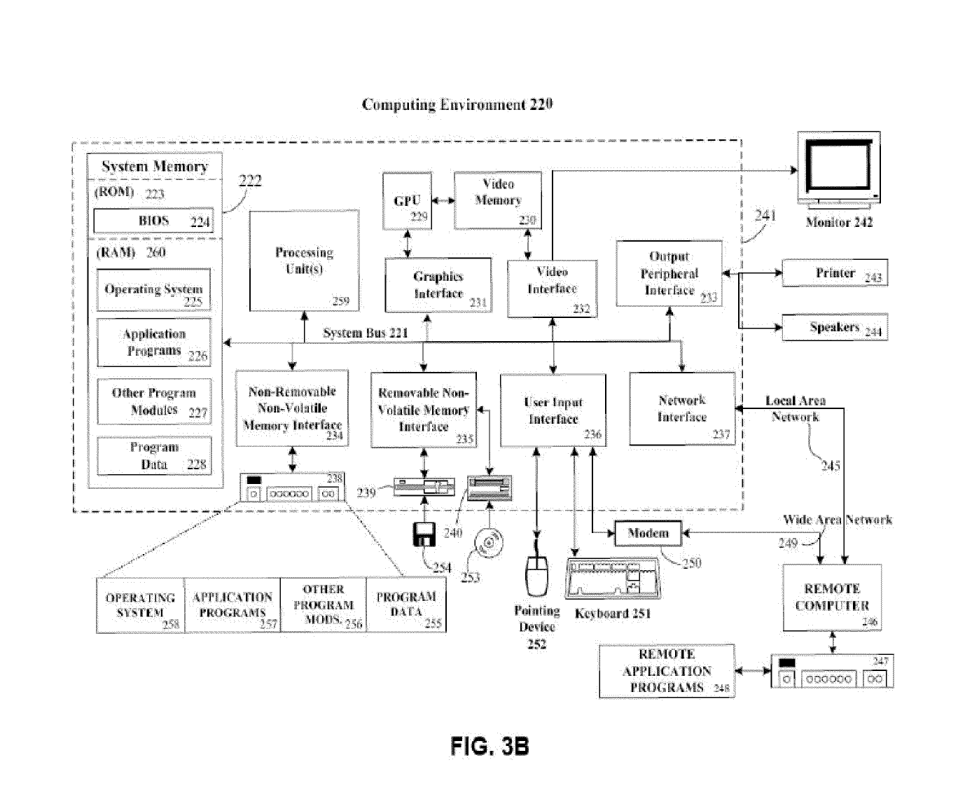

FIG. 3A illustrates an example embodiment of a computing environment that may be used to interpret one or more gestures in a target recognition, analysis, and tracking system. The computing environment such as the computing environment 12 described above with respect to FIGS. 1A-2 may be a multimedia console 100, such as a gaming console. As shown in FIG. 3A, the multimedia console 100 has a central processing unit (CPU) 101 having a level 1 cache 102, a level 2 cache 104, and a flash ROM 106. The level 1 cache 102 and a level 2 cache 104 temporarily store data and hence reduce the number of memory access cycles, thereby improving processing speed and throughput. The CPU 101 may be provided having more than one core, and thus, additional level 1 and level 2 caches 102 and 104. The flash ROM 106 may store executable code that is loaded during an initial phase of a boot process when the multimedia console 100 is powered ON.

A graphics processing unit (GPU) 108 and a video encoder/video codec (coder/decoder) 114 form a video processing pipeline for high speed and high resolution graphics processing. Data is carried from the GPU 108 to the video encoder/video codec 114 via a bus. The video processing pipeline outputs data to an A/V (audio/video) port 140 for transmission to a television or other display. A memory controller 110 is connected to the GPU 108 to facilitate processor access to various types of memory 112, such as, but not limited to, a RAM.

The multimedia console 100 includes an I/O controller 120, a system management controller 122, an audio processing unit 123, a network interface controller 124, a first USB host controller 126, a second USB host controller 128 and a front panel I/O subassembly 130 that are preferably implemented on a module 118. The USB controllers 126 and 128 serve as hosts for peripheral controllers 142(1)-142(2), a wireless adapter 148, and an external memory device 146 (e.g., flash memory, external CD/DVD ROM drive, removable media, etc.). The network interface 124 and/or wireless adapter 148 provide access to a network (e.g., the Internet, home network, etc.) and may be any of a wide variety of various wired or wireless adapter components including an Ethernet card, a modem, a Bluetooth module, a cable modem, and the like.

System memory 143 is provided to store application data that is loaded during the boot process. A media drive 144 is provided and may comprise a DVD/CD drive, hard drive, or other removable media drive, etc. The media drive 144 may be internal or external to the multimedia console 100. Application data may be accessed via the media drive 144 for execution, playback, etc. by the multimedia console 100. The media drive 144 is connected to the I/O controller 120 via a bus, such as a Serial ATA bus or other high speed connection (e.g., IEEE 1394).

The system management controller 122 provides a variety of service functions related to assuring availability of the multimedia console 100. The audio processing unit 123 and an audio codec 132 form a corresponding audio processing pipeline with high fidelity and stereo processing. Audio data is carried between the audio processing unit 123 and the audio codec 132 via a communication link. The audio processing pipeline outputs data to the A/V port 140 for reproduction by an external audio player or device having audio capabilities.

The front panel I/O subassembly 130 supports the functionality of the power button 150 and the eject button 152, as well as any LEDs (light emitting diodes) or other indicators exposed on the outer surface of the multimedia console 100. A system power supply module 136 provides power to the components of the multimedia console 100. A fan 138 cools the circuitry within the multimedia console 100.

The CPU 101, GPU 108, memory controller 110, and various other components within the multimedia console 100 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 100 is powered ON, application data may be loaded from the system memory 143 into memory 112 and/or caches 102, 104 and executed on the CPU 101. The application may present a graphical user interface that provides a consistent user experience when navigating to different media types available on the multimedia console 100. In operation, applications and/or other media contained within the media drive 144 may be launched or played from the media drive 144 to provide additional functionalities to the multimedia console 100.

The multimedia console 100 may be operated as a standalone system by simply connecting the system to a television or other display. In this standalone mode, the multimedia console 100 allows one or more users to interact with the system, watch movies, or listen to music. However, with the integration of broadband connectivity made available through the network interface 124 or the wireless adapter 148, the multimedia console 100 may further be operated as a participant in a larger network community.

When the multimedia console 100 is powered ON, a set amount of hardware resources are reserved for system use by the multimedia console operating system. These resources may include a reservation of memory (e.g., 16 MB), CPU and GPU cycles (e.g., 5%), networking bandwidth (e.g., 8 kbs), etc. Because these resources are reserved at system boot time, the reserved resources do not exist from the application's view.

In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., popups) are displayed by using a GPU interrupt to schedule code to render popup into an overlay. The amount of memory required for an overlay depends on the overlay area size and the overlay preferably scales with screen resolution. Where a full user interface is used by the concurrent system application, it is preferable to use a resolution independent of the application resolution. A scaler may be used to set this resolution such that the need to change frequency and cause a TV resynch is eliminated.

After the multimedia console 100 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 101 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Input devices (e.g., controllers 142(1) and 142(2)) are shared by gaming applications and system applications. The input devices are not reserved resources, but are to be switched between system applications and the gaming application such that each will have a focus of the device. The application manager preferably controls the switching of input stream, without knowledge of the gaming application's knowledge and a driver maintains state information regarding focus switches. The cameras 26, 28 and capture device 20 may define additional input devices for the console 100.

FIG. 3B illustrates another example embodiment of a computing environment 220 that may be the computing environment 12 shown in FIGS. 1A-2 used to interpret one or more gestures in a target recognition, analysis, and tracking system. The computing system environment 220 is only one example of a suitable computing environment and is not intended to suggest any limitation as to the scope of use or functionality of the presently disclosed subject matter. Neither should the computing environment 220 be interpreted as having any dependency or requirement relating to any one or combination of components illustrated in the exemplary operating environment 220. In some embodiments, the various depicted computing elements may include circuitry configured to instantiate specific aspects of the present disclosure. For example, the term circuitry used in the disclosure can include specialized hardware components configured to perform function(s) by firmware or switches. In other example embodiments, the term circuitry can include a general purpose processing unit, memory, etc., configured by software instructions that embody logic operable to perform function(s). In example embodiments where circuitry includes a combination of hardware and software, an implementer may write source code embodying logic and the source code can be compiled into machine readable code that can be processed by the general purpose processing unit. Since one skilled in the art can appreciate that the state of the art has evolved to a point where there is little difference between hardware, software, or a combination of hardware/software, the selection of hardware versus software to effectuate specific functions is a design choice left to an implementer. More specifically, one of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer.

In FIG. 3B, the computing environment 220 comprises a computer 241, which typically includes a variety of computer readable media. Computer readable media can be any available media that can be accessed by computer 241 and includes both volatile and nonvolatile media, removable and non-removable media. The system memory 222 includes computer storage media in the form of volatile and/or nonvolatile memory such as ROM 223 and RAM 260. A basic input/output system 224 (BIOS), containing the basic routines that help to transfer information between elements within computer 241, such as during start-up, is typically stored in ROM 223. RAM 260 typically contains data and/or program modules that are immediately accessible to and/or presently being operated on by processing unit 259. By way of example, and not limitation, FIG. 3B illustrates operating system 225, application programs 226, other program modules 227, and program data 228.

The computer 241 may also include other removable/non-removable, volatile/nonvolatile computer storage media. By way of example only, FIG. 3B illustrates a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 238 is typically connected to the system bus 221 through a non-removable memory interface such as interface 234, and magnetic disk drive 239 and optical disk drive 240 are typically connected to the system bus 221 by a removable memory interface, such as interface 235.

The drives and their associated computer storage media discussed above and illustrated in FIG. 3B, provide storage of computer readable instructions, data structures, program modules and other data for the computer 241. In FIG. 3B, for example, hard disk drive 238 is illustrated as storing operating system 258, application programs 257, other program modules 256, and program data 255. Note that these components can either be the same as or different from operating system 225, application programs 226, other program modules 227, and program data 228. Operating system 258, application programs 257, other program modules 256, and program data 255 are given different numbers here to illustrate that, at a minimum, they are different copies. A user may enter commands and information into the computer 241 through input devices such as a keyboard 251 and a pointing device 252, commonly referred to as a mouse, trackball or touch pad. Other input devices (not shown) may include a microphone, joystick, game pad, satellite dish, scanner, or the like. These and other input devices are often connected to the processing unit 259 through a user input interface 236 that is coupled to the system bus, but may be connected by other interface and bus structures, such as a parallel port, game port or a universal serial bus (USB). The cameras 26, 28 and capture device 20 may define additional input devices for the console 100. A monitor 242 or other type of display device is also connected to the system bus 221 via an interface, such as a video interface 232. In addition to the monitor, computers may also include other peripheral output devices such as speakers 244 and printer 243, which may be connected through an output peripheral interface 233.

The computer 241 may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer 241, although only a memory storage device 247 has been illustrated in FIG. 3B. The logical connections depicted in FIG. 3B include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 is connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device. By way of example, and not limitation, FIG. 3B illustrates remote application programs 248 as residing on memory device 247. It will be appreciated that the network connections shown are exemplary and other means of establishing a communications link between the computers may be used.

As indicated above, gesture recognizer engine 190 within computing environment 12 is provided for receiving gesture information and identifying gestures and gesture styles from this information. In particular, gesture recognizer engine 190 includes a first order recognition engine 190a for detecting gestures, and a second order recognition engine 190b for detecting qualitative aspects of a detected gesture. The first order recognition engine 190a will now be described, followed by a description of the second order recognition engine 190b.

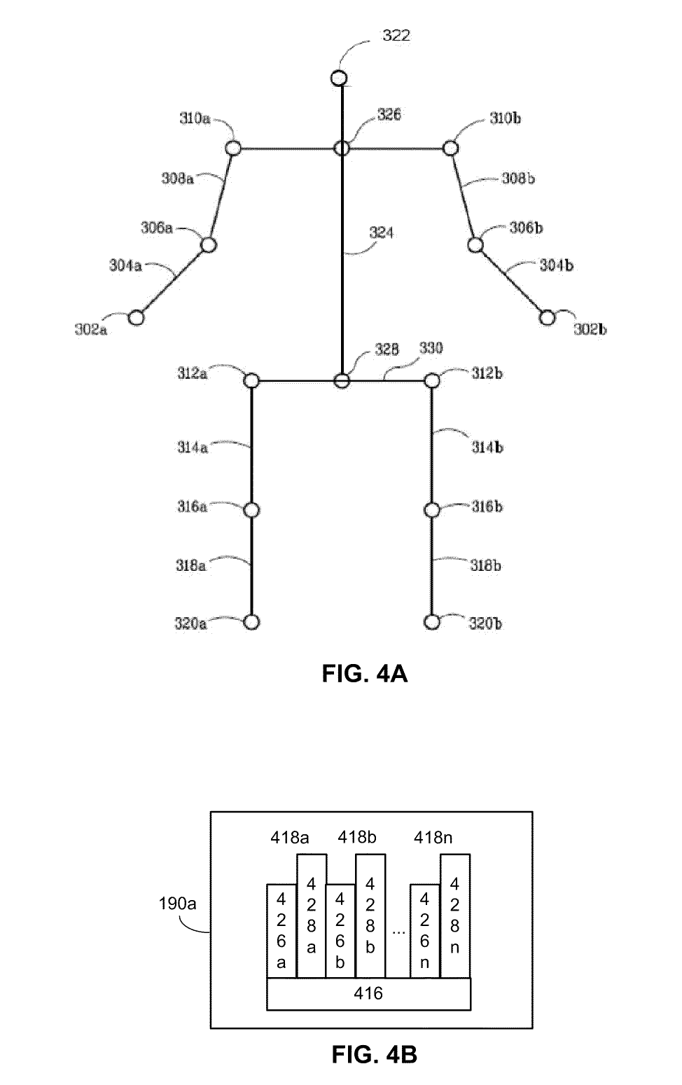

FIG. 4A depicts an example skeletal mapping of a user that may be generated from the capture device 20. In this embodiment, a variety of joints and bones are identified: each hand 302, each forearm 304, each elbow 306, each bicep 308, each shoulder 310, each hip 312, each thigh 314, each knee 316, each foreleg 318, each foot 320, the head 322, the torso 324, the top 326 and the bottom 328 of the spine, and the waist 330. Where more points are tracked, additional features may be identified, such as the bones and joints of the fingers or toes, or individual features of the face, such as the nose and eyes.

Through moving his/her body, a user may create gestures. A gesture comprises a motion or pose by a user that may be captured as image data and parsed for meaning. A gesture may be dynamic, comprising a motion, such as mimicking throwing a ball. A gesture may be a static pose, such as holding one's crossed forearms 304 in front of his torso 324. A gesture may also incorporate props, such as by swinging a mock sword. A gesture may comprise more than one body part, such as clapping the hands 302 together, or a subtler motion, such as pursing one's lips.

Gestures may be used for input by the first order recognition engine 190a in a general computing context. For instance, various motions of the hands 302 or other body parts may correspond to common system wide tasks such as navigate up or down in a hierarchical list, open a file, close a file, and save a file. Gestures may also be used by the first order recognition engine 190a in a video-game-specific context, depending on the game. For instance, with a driving game, various motions of the hands 302 and feet 320 may correspond to steering a vehicle in a direction, shifting gears, accelerating, and breaking.

A user may generate a gesture that corresponds to walking or running, by walking or running in place himself The user may alternately lift and drop each leg 312-320 to mimic walking without moving. The first order recognition engine 190a may parse this gesture by analyzing each hip 312 and each thigh 314. A step may be recognized when one hip-thigh angle (as measured relative to a vertical line, wherein a standing leg has a hip-thigh angle of 0°, and a forward horizontally extended leg has a hip-thigh angle of 90°) exceeds a certain threshold relative to the other thigh. A walk or run may be recognized after some number of consecutive steps by alternating legs. The time between the two most recent steps may be thought of as a period. After some number of periods where that threshold angle is not met, the system may determine that the walk or running gesture has ceased.

Given a “walk or run” gesture, an application may set values for parameters associated with this gesture. These parameters may include the above threshold angle, the number of steps required to initiate a walk or run gesture, a number of periods where no step occurs to end the gesture, and a threshold period that determines whether the gesture is a walk or a run. A fast period may correspond to a run, as the user will be moving his legs quickly, and a slower period may correspond to a walk.

A gesture may be associated with a set of default parameters at first that the application may override with its own parameters. In this scenario, an application is not forced to provide parameters, but may instead use a set of default parameters that allow the gesture to be recognized in the absence of application-defined parameters.

There are a variety of outputs that may be associated with the gesture. There may be a baseline “pass or fail” as to whether a gesture is occurring. There also may be a confidence level, which corresponds to the likelihood that the user's tracked movement corresponds to the gesture. This could be a linear scale that ranges over floating point numbers between 0 and 1, inclusive. Wherein an application receiving this gesture information cannot accept false-positives as input, it may use only those recognized gestures that have a high confidence level, such as at least 0.95. Where an application must recognize every instance of the gesture, even at the cost of false-positives, it may use gestures that have at least a much lower confidence level, such as those merely greater than 0.2. The gesture may have an output for the time between the two most recent steps, and where only a first step has been registered, this may be set to a reserved value, such as −1 (since the time between any two steps must be positive). The gesture may also have an output for the highest thigh angle reached during the most recent step.

Another exemplary gesture is a “heel lift jump.” In this, a user may create the gesture by raising his heels off the ground, but keeping his toes planted. Alternatively, the user may jump into the air where his feet 320 leave the ground entirely. The system may parse the skeleton for this gesture by analyzing the angle relation of the shoulders 310, hips 312 and knees 316 to see if they are in a position of alignment equal to standing up straight. Then these points and the upper 326 and lower 328 spine points may be monitored for any upward acceleration. A sufficient combination of acceleration may trigger a jump gesture.

Given this “heel lift jump” gesture, an application may set values for parameters associated with this gesture. The parameters may include the above acceleration threshold, which determines how fast some combination of the user's shoulders 310, hips 312 and knees 316 must move upward to trigger the gesture, as well as a maximum angle of alignment between the shoulders 310, hips 312 and knees 316 at which a jump may still be triggered.

The outputs may comprise a confidence level, as well as the user's body angle at the time of the jump.

Setting parameters for a gesture based on the particulars of the application that will receive the gesture is important in accurately identifying gestures. Properly identifying gestures and the intent of a user greatly helps in creating a positive user experience. Where a gesture recognizer system 190 is too sensitive, and even a slight forward motion of the hand 302 is interpreted as a throw, the user may become frustrated because gestures are being recognized where he has no intent to make a gesture, and thus, he lacks control over the system. Where a gesture recognizer system is not sensitive enough, the system may not recognize conscious attempts by the user to make a throwing gesture, frustrating him in a similar manner. At either end of the sensitivity spectrum, the user becomes frustrated because he cannot properly provide input to the system.

Another parameter to a gesture may be a distance moved. Where a user's gestures control the actions of an avatar in a virtual environment, that avatar may be arm's length from a ball. If the user wishes to interact with the ball and grab it, this may require the user to extend his arm 302-310 to full length while making the grab gesture. In this situation, a similar grab gesture where the user only partially extends his arm 302-310 may not achieve the result of interacting with the ball.

A gesture or a portion thereof may have as a parameter a volume of space in which it must occur. This volume of space may typically be expressed in relation to the body where a gesture comprises body movement. For instance, a football throwing gesture for a right-handed user may be recognized only in the volume of space no lower than the right shoulder 310a, and on the same side of the head 322 as the throwing arm 302a-310a. It may not be necessary to define all bounds of a volume, such as with this throwing gesture, where an outer bound away from the body is left undefined, and the volume extends out indefinitely, or to the edge of the scene that is being monitored. As explained below, even where a given gesture is defined by a volume of space (such as from the shoulder up for a throwing motion), motions, velocities and accelerations of other joints may still be monitored during the gesture for determining gesture style.

FIG. 4B provides further details of one exemplary embodiment of the first order gesture recognition engine 190a of FIG. 2. As shown, the first order gesture recognition engine 190a may comprise at least one filter 418 to determine a gesture or gestures. A filter 418 comprises information defining a gesture 426 (hereinafter referred to as a “gesture”) along with parameters, or metadata, 428 for that gesture for use by the first and second order gesture recognition engines 190a and 190b. For instance, a throw, which comprises motion of one of the hands from behind the rear of the body to past the front of the body, may be implemented as a gesture 426 comprising information representing the movement of one of the hands of the user from behind the rear of the body to past the front of the body, as that movement would be captured by the depth camera. Parameters 428 may then be set for that gesture 426. Where the gesture 426 is a throw, a parameter 428 that is used by the first order gesture recognition engine 190a may be a threshold velocity that the hand has to reach, a distance the hand must travel (either absolute, or relative to the size of the user as a whole), and a confidence rating by the recognizer engine that the gesture occurred. These parameters 428 for the gesture 426 may vary between applications, between contexts of a single application, or within one context of one application over time. As explained below, additional metadata 428 may be stored for use by the second order gesture recognition engine 190b.

Filters may be modular or interchangeable. In an embodiment, a filter has a number of inputs, each of those inputs having a type, and a number of outputs, each of those outputs having a type. In this situation, a first filter may be replaced with a second filter that has the same number and types of inputs and outputs as the first filter without altering any other aspect of the recognizer engine architecture. For instance, there may be a first filter for driving that takes as input skeletal data and outputs a confidence that the gesture associated with the filter is occurring and an angle of steering. Where one wishes to substitute this first driving filter with a second driving filter—perhaps because the second driving filter is more efficient and requires fewer processing resources—one may do so by simply replacing the first filter with the second filter so long as the second filter has those same inputs and outputs—one input of skeletal data type, and two outputs of confidence type and angle type.

The first order gesture recognition engine 190a may not make user of metadata 428 associated with a given filter. For instance, a “user height” filter that returns the user's height may not allow for any parameters that may be tuned. An alternate “user height” filter may have tunable parameters—such as whether to account for a user's footwear, hairstyle, headwear and posture in determining the user's height.

Inputs to a filter may comprise things such as joint data about a user's joint position, like angles formed by the bones that meet at the joint, RGB color data from the scene, and the rate of change of a kinetic aspect of the user. Outputs from a filter may comprise things such as the confidence that a given gesture is being made, the speed at which a gesture motion is made, and a time at which a gesture motion is made.

A context may be a cultural context, and it may be an environmental context. A cultural context refers to the culture of a user using a system. Different cultures may use similar gestures to impart markedly different meanings. For instance, an American user who wishes to tell another user to “look” or “use his eyes” may put his index finger on his head close to the distal side of his eye. However, to an Italian user, this gesture may be interpreted as a reference to the mafia.

Similarly, there may be different contexts among different environments of a single application. Take a first-person shooter game that involves operating a motor vehicle. While the user is on foot, making a fist with the fingers towards the ground and extending the fist in front and away from the body may represent a punching gesture. While the user is in the driving context, that same motion may represent a “gear shifting” gesture. There may also be one or more menu environments, where the user can save his game, select among his character's equipment or perform similar actions that do not comprise direct game-play. In that environment, this same gesture may have a third meaning, such as to select something or to advance to another screen.

The first order gesture recognition engine 190a may have a base recognizer engine 416 that provides functionality to a gesture filter 418. In an embodiment, the functionality that the recognizer engine 416 implements includes an input-over-time archive that tracks recognized gestures and other input, a Hidden Markov Model implementation (where the modeled system is assumed to be a Markov process—one where a present state encapsulates any past state information necessary to determine a future state, so no other past state information must be maintained for this purpose—with unknown parameters, and hidden parameters are determined from the observable data), as well as other functionality required to solve particular instances of gesture recognition.

Filters 418 are loaded and implemented on top of the base recognizer engine 416 and can utilize services provided by the engine 416 to all filters 418. In an embodiment, the base recognizer engine 416 processes received data to determine whether it meets the requirements of any filter 418. Since these provided services, such as parsing the input, are provided once by the base recognizer engine 416 rather than by each filter 418, such a service need only be processed once in a period of time as opposed to once per filter 418 for that period, so the processing required to determine gestures is reduced.

An application may use the filters 418 provided by the first order gesture recognition engine 190a, or it may provide its own filter 418, which plugs in to the base recognizer engine 416. In an embodiment, all filters 418 have a common interface to enable this plug-in characteristic.

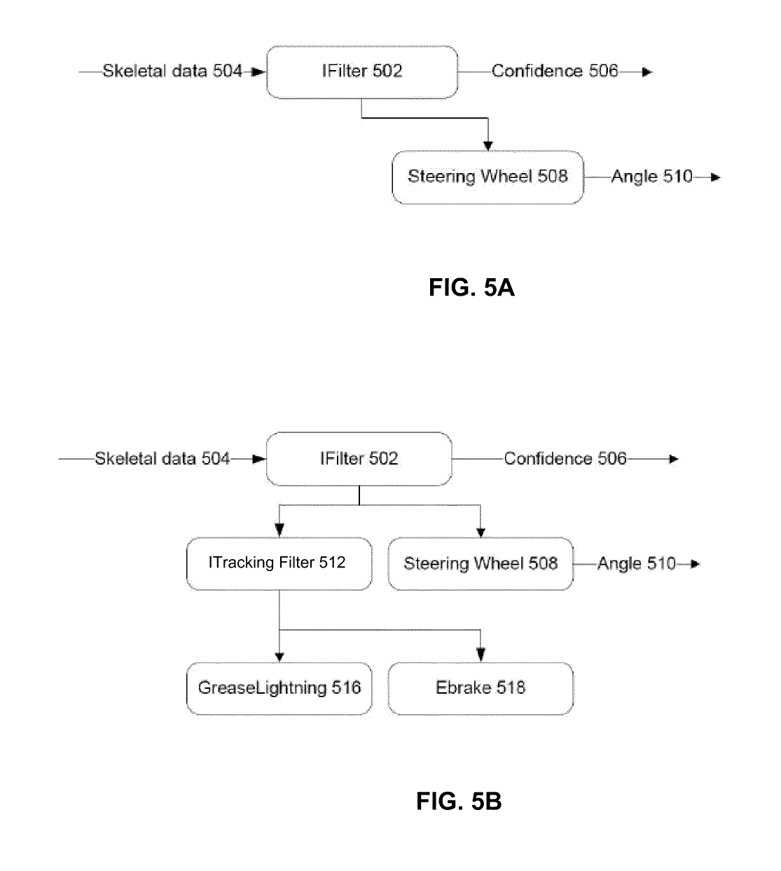

FIGS. 5A and 5B depict more complex gestures or filters 418 created from stacked gestures or filters 418. Gestures can stack on each other. That is, more than one gesture may be expressed by a user at a single time. For instance, rather than disallowing any input but a throw when a throwing gesture is made, or requiring that a user remain motionless save for the components of the gesture (e.g. stand still while making a throwing gesture that involves only one arm). Where gestures stack, a user may make a jumping gesture and a throwing gesture simultaneously, and both of these gestures will be recognized by the gesture engine.

FIG. 5A depicts a simple gesture filter 418 according to the stacking paradigm. The IFilter filter 502 is a basic filter 418 that may be used in every gesture filter. IFilter 502 takes user position data 504 and outputs a confidence level 506 that a gesture has occurred. It also feeds that position data 504 into a Steering Wheel filter 508 that takes it as an input and outputs an angle to which the user is steering (e.g. 40 degrees to the right of the user's current bearing) 510.

FIG. 5B depicts a more complex gesture that stacks filters 418 onto the gesture filter of FIG. 5A. In addition to IFilter 502 and SteeringWheel 508, there is an ITracking filter 512 that receives position data 504 from IFilter 502 and outputs the amount of progress the user has made through a gesture 514. ITracking 512 also feeds position data 504 to GreaseLightning 516 and EBrake 518, which are filters 418 regarding other gestures that may be made in operating a vehicle, such as using the emergency brake.

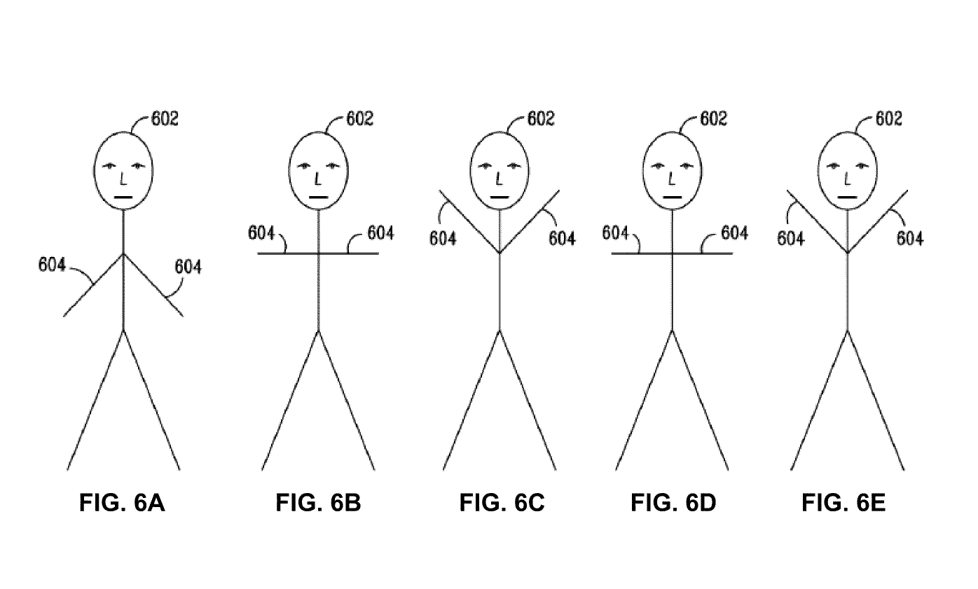

FIGS. 6A-6E depict an example gesture that a user 602 may make to signal for a “fair catch” in a football video game. These figures depict the user at points in time, with FIG. 6A being the first point in time, and FIG. 6E being the last point in time. Each of these figures may correspond to a snapshot or frame of image data as captured by a depth camera 22, though not necessarily consecutive frames of image data, as the depth camera 22 may be able to capture frames more rapidly than the user may cover the distance. For instance, this gesture may occur over a period of 3 seconds, and where a depth camera captures data at 40 frames per second, it would capture 60 frames of image data while the user 602 made this fair catch gesture.

In FIG. 6A, the user 602 begins with his arms 604 down at his sides. He then raises them up and above his shoulders as depicted in FIG. 6B and then further up, to the approximate level of his head, as depicted in FIG. 6C. From there, he lowers his arms 604 to shoulder level, as depicted in FIG. 6D, and then again raises them up, to the approximate level of his head, as depicted in FIG. 6E. Where a system captures these positions by the user 602 without any intervening position that may signal that the gesture is cancelled, or another gesture is being made, it may have the fair catch gesture filter output a high confidence level that the user 602 made the fair catch gesture.

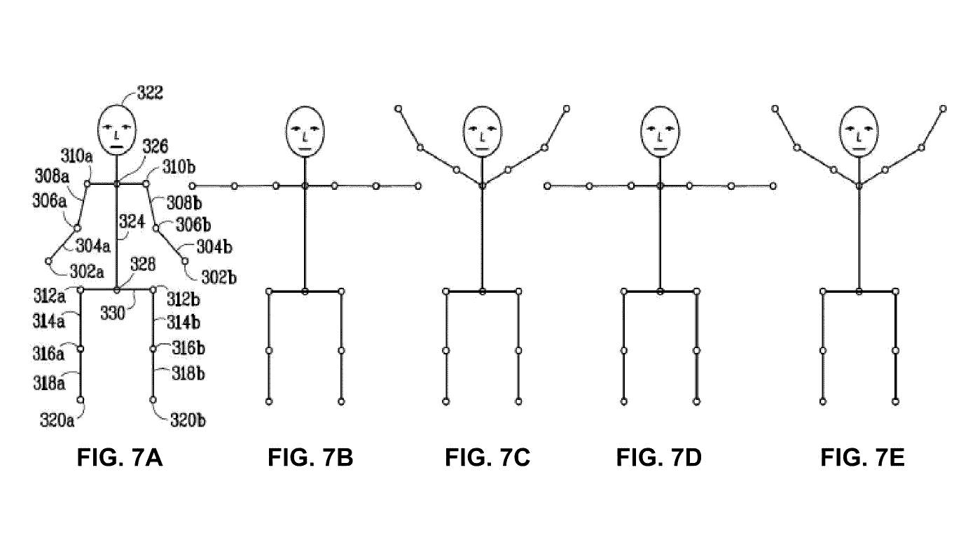

FIG. 7 depicts the example “fair catch” gesture of FIG. 5 as each frame of image data has been parsed to produce a skeletal map of the user. The system, having produced a skeletal map from the depth image of the user, may now determine how that user's body moves over time, and from that, parse the gesture.

In FIG. 7A, the user's shoulders 310, are above his elbows 306, which in turn are above his hands 302. The shoulders 310, elbows 306 and hands 302 are then at a uniform level in FIG. 7B. The system then detects in FIG. 7C that the hands 302 are above the elbows 306, which are above the shoulders 310. In FIG. 7D, the user has returned to the position of FIG. 7B, where the shoulders 310, elbows 306 and hands 302 are at a uniform level. In the final position of the gesture, shown in FIG. 7E, the user returns to the position of FIG. 7C, where the hands 302 are above the elbows 306, which are above the shoulders 310.

While the capture device 20 captures a series of still images, such that in any one image the user appears to be stationary, the user is moving in the course of performing this gesture (as opposed to a stationary gesture, as discussed supra). The system is able to take this series of poses in each still image, and from that determine the confidence level of the moving gesture that the user is making. Moreover, as indicated above and explained below, the first order gesture recognition engine 190a may additionally store metadata 428 associated with the gesture shown in FIGS. 7A-7E to determine a gesture style associated with the user's gesture.

In performing the gesture, a user may be unable to create an angle as shown by the right shoulder 310a, right elbow 306a and right hand 302a of, for example, between 140° and 145°. So, the application using the filter 418 for the fair catch gesture 426 may tune the associated parameters 428 to best serve the specifics of the application. For instance, the positions in FIGS. 7C and 7E may be recognized any time the user has his hands 302 above his shoulders 310, without regard to elbow 306 position. A set of parameters that are more strict may require that the hands 302 be above the head 310 and that the elbows 306 be both above the shoulders 310 and between the head 322 and the hands 302. Additionally, the parameters 428 for a fair catch gesture 426 may require that the user move from the position of FIG. 7A through the position of FIG. 7E within a specified period of time, such as 1.5 seconds, and if the user takes more than 1.5 seconds to move through these positions, it will not be recognized as the fair catch 418, and a very low confidence level may be output.

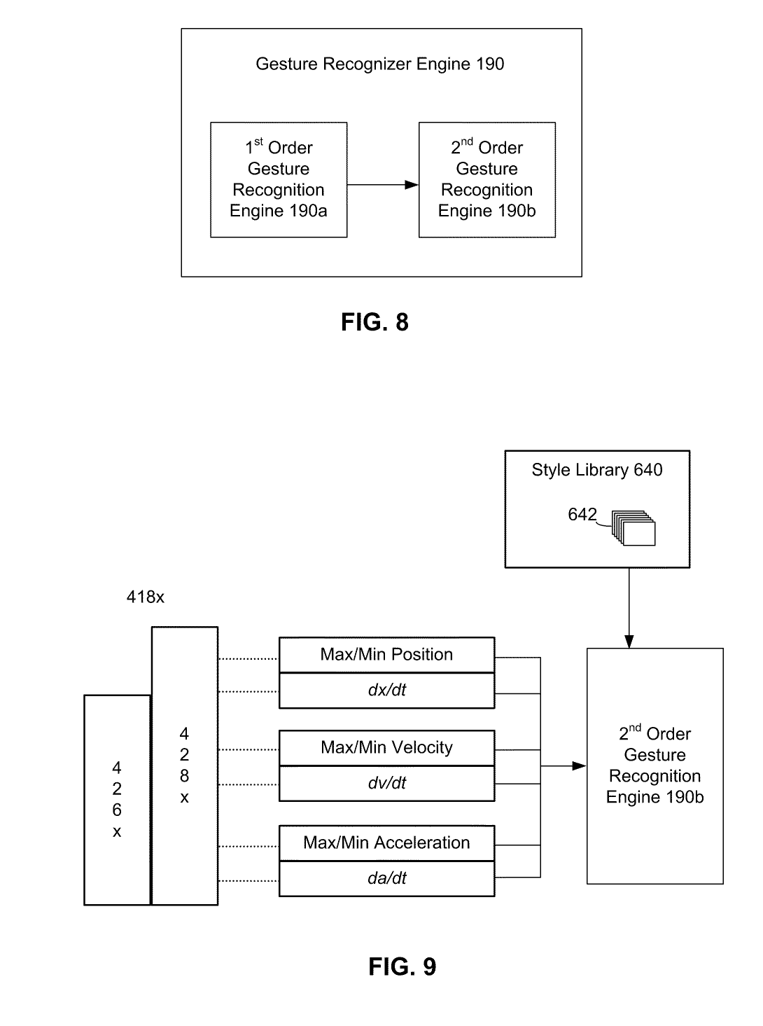

As indicated above, in addition to detecting gestures, the present technology also examines qualitative aspects of a gesture, and provides feedback to the user based on detection of one or more predefined qualitative attributes. These qualitative attributes are the style with which a given gesture or user motion is performed. As shown in the block diagrams of FIGS. 8 and 9, the style of a given gesture or motion is determined by the second order gesture recognition engine 190b based on information received from the first order gesture recognition engine 190a.

Referring to FIG. 9, as explained above, a given filter 418 includes a defined gesture 426 and metadata 428 either sensed by the depth camera 22 or mathematically determined from data sensed by depth camera 22. In general, metadata 428 provides information on how the gesture 426 was performed. Metadata 428 is taken and stored over some predefined period of time, such as for example the length of time it takes to perform a gesture 426 or motion. It may further encompass a predefined period of time before and/or after a gesture or motion. Alternatively, the period of time may be some predefined set period of time, such as for example one to five seconds worth of data, or alternatively two to three seconds worth of data, counted backwards from the end of the gesture.

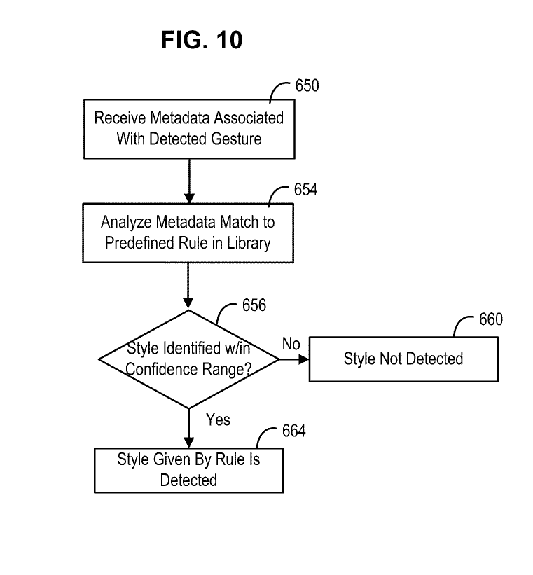

The operation of the second order gesture recognition engine 190b will now be explained with reference to the block diagram of FIG. 9 and the flow chart of FIG. 10. Upon detection of a gesture 426 by the first order gesture recognition engine 190a, the metadata 428 associated with that gesture is passed to the second order gesture recognition engine 190b in step 650.

There is a variety of metadata which may be used to determine whether a gesture or motion was performed with a predefined style. This metadata is generated from movement by the user and captured by capture device 20. In embodiments, this metadata may be a measurement of the maximum and minimum position of the user, measured in x, y, z space relative to a position of depth camera 22. This may be the x, y and z minimum and maximum image plane positions detected by the capture device 20. The metadata may also include a measurement or measurements of the change in position over time, dx/dt, for discrete time intervals over which metadata 428 is taken. The discrete time intervals may be as long as the entire time to perform the gesture or motion or as small as a single frame from the depth camera 22. This change in position metadata gives the different velocities of the user's body during the time that the user is performing the detected gesture (or other defined time period mentioned above).

In embodiments, the metadata may further include a measurement of the maximum and minimum velocity of the user, measured in x, y, z space. The metadata may also include a measurement or measurements of the change in velocity over time, dv/dt, for discrete time intervals over which metadata 428 is taken. This change in velocity metadata gives the different accelerations of the user's body during the time that the user is performing the detected gesture (or other defined time period mentioned above).

In embodiments, the metadata may further include a measurement of the maximum and minimum acceleration of the user, measured in x, y, z space. The metadata may also include a measurement or measurements of the change in acceleration over time, da/dt, for discrete time intervals over which metadata 428 is taken. This change in acceleration metadata gives different jerk measurements of the user's body during the time that the user is performing the detected gesture (or other defined time period mentioned above).

It is understood that other parameters may be used in addition to or instead of one or more of the above parameters. In on embodiment, second order differential equations may be derived which describe the trajectory of a body part as it moves in 3D space. These equations may also be used as metadata received by the engine 190b to detect a predefined style. In a further embodiment, the camera 22 may take measurements of facial expressions of the user, which may then be used with other parameters to make determinations as to the style with which a given gesture or movement was performed by the user.

In embodiments, each of the above kinetic parameters relating to position, velocity and acceleration may be taken and stored for one or more of the body parts 302 through 330 described above with respect to FIG. 4A. Thus, in embodiments, the second order gesture recognition engine 190b can receive a full picture of kinetic activity of all points in the user's body shown in FIG. 4A.

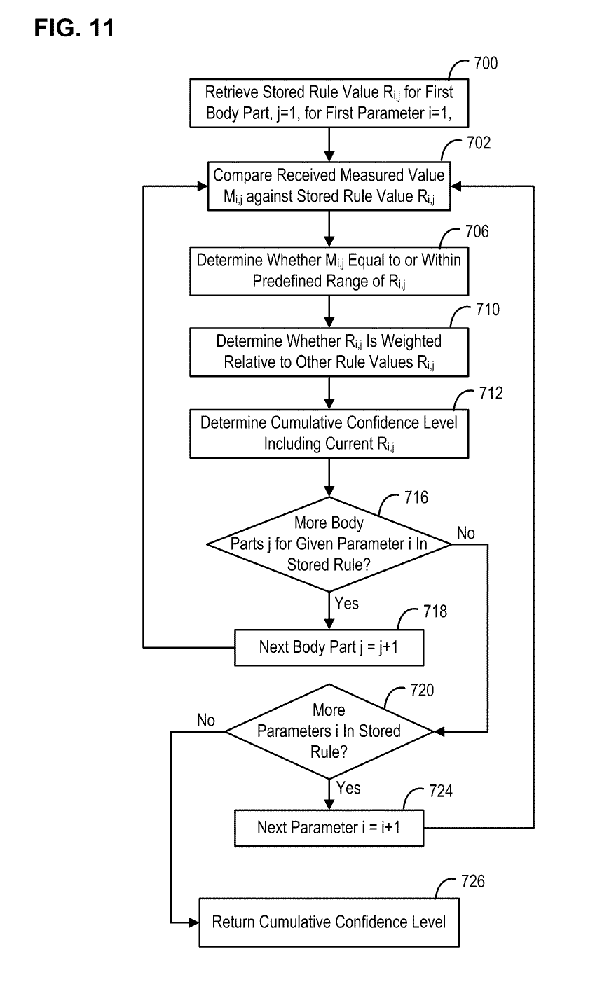

This metadata 428 is forwarded by the first order gesture recognition engine 190a to the second order gesture recognition engine 190b. The second order gesture recognition engine 190b then analyzes the received metadata in step 654 to see if the metadata matches any predefined rule stored within a style library 640. Step 654 is described below with reference to FIG. 9 and the flowchart of FIG. 11.

Style library 640 includes a plurality of stored rules 642 which describe when particular kinetic motions indicated by the metadata 428 are to be interpreted as a predefined style. Rules may be created by a game author, by a host of the gaming platform or by users themselves. A rule is a definition of a given set of parameter values or ranges of values. When the user moves in such a way (taking into consideration the above-described parameters) so as to satisfy a rule, the second order gesture recognition engine 190b recognizes that movement as a style. Stated another way, a rule is a predefined stored group of values or ranges of values for one or more metadata parameters (maximum/minimum position, change in position over time, maximum or minimum velocity, change in velocity over time, maximum or minimum acceleration, change in acceleration over time) for one or more body parts, which, when taken as a whole, are indicative of a particular style associated with a gesture.

Following is a description of a few rules, and general parameters making up the rules, for illustrative purposes. It is understood that there may be a wide variety of additional rules covering a wide variety of styles according to the present technology. As one example, the first order gesture recognition engine 190a may determine that a user has performed a ducking gesture, i.e., lowering closer to the ground. There are a wide variety of styles of ducking. A first user may crouch down on all fours, while a second user may “hit the deck” so as to quickly sprawl out flat against the ground.

Each of these motions may be recognized by the first order gesture recognition engine 190a as ducking. However, based on at least the change of position over time, and the change of velocity over time, of all portions of the user's body, the second order gesture recognition engine 190b can recognize a style of ducking where the user has hit the deck. This style of ducking may be recognized by a rule; that is, parameters relating to the change of distance, change of velocity, etc. defining when a user is considered to have hit the deck may be quantified and stored in a rule. When the second order gesture recognition engine 190b recognizes that the user has acted in a way that meets this rule, then the user may receive some sort of reward under the game metric and/or the user's gaming experience may be personalized to show that the system has recognized his or her own style of ducking. For example, the user's avatar may duck with the same style and the ground may shake. Other in-game style recognition indications may further be provided.

As another example of style recognition, a game may ask a user to perform dance moves by moving their feet forward, back and side to side. The first order gesture recognition engine 190a will be able to determine whether a user has properly performed the steps of the dance as indicated by the game. However, by analyzing the metadata, the second order gesture recognition engine 190b can examine the change of position data, the change of velocity data, etc. and determine whether the transition between steps is performed smoothly or in more of a jerky manner. When performed smoothly for example, the derivative of the velocity parameter will be at or near zero. When the second order gesture recognition engine 190b determines that the steps are performed smoothly, the user may be rewarded within the game and/or the user's avatar may take some action or be presented in a particular way so as to personalize the game experience for the user.

In an example within a boxing game, such as shown in FIGS. 1A and 1B, a user may be moving around energetically at the close of a round, indicating that the user is not tired. Such movement may be characterized by a lot of position changes at a given velocity, and a rule may be set to look for such movement. Alternatively, a user may begin dancing in the middle of a boxing round to taunt the opponent. Such dancing may be characterized by rhythmic and/or repeated patterns of movement, velocities and accelerations for different body parts. As such, a rule may be set to look for these kinetic parameters. Upon detecting an energetic close of a round, or a dance during a round, these styles may be reflected by altering the user's avatar within the game so as to personalize the experience for the user.

In a further example related to a baseball game, the first order gesture recognition engine 190a may recognize that a user has swung with a given velocity at the right time so as to determine that the user has hit a virtual baseball a particular distance, such as for example a home run. However, the second order gesture recognition engine 190b may analyze the metadata before, during and/or after the swing and determine that the user waited to the very last moment before initiating the swing. This may be considered stylistically significant, and there may be a rule having a set of metadata indicative of a last minute swing. For example, it may be characterized in relatively little motion until a point just before the time when a swing needs to be sensed for the underlying gesture, at which time there is a spike in position, velocity and/or acceleration. Again, a rule may be set defining these parameters, and where the second order gesture recognition engine detects metadata satisfying this rule, the user may be rewarded within the game and/or the user's avatar may take some action or be presented in a particular way so as to personalize the game experience for the user.

In another baseball example, a first user may swing a bat using only their arms and achieve a given swing velocity. However, a second user may perform a more “textbook” swing by first striding, rotating their hips, rotating their shoulders, and then swinging their arms, all in proper succession. The second order gesture recognition engine 190b may analyze the kinetic data for different points in the user's body and recognize the positions, velocities, accelerations, etc. associated with the above-described textbook swing. The user may be rewarded within the game and/or the user's avatar may take some action or be presented in a particular way so as to personalize the game experience for the user.

In a still further baseball example, upon detection of a swing by the first order gesture recognition engine 190a, the second order gesture recognition engine 190b may review the metadata and determine that the user pointed prior to the swing, similar to Babe Ruth's called home run shot in the 1932 World Series. The motions involved with pointing may be codified into a rule. Upon making the determination that the user's motions satisfy this rule, the user may be rewarded within the game and/or the user's avatar may take some action or be presented in a particular way so as to personalize the game experience for the user. For example, the appearance of the user's avatar may transform into the likeness of Babe Ruth when trotting around the bases. This example illustrates that the metadata reviewed by the second order gesture recognition engine may not solely be limited to metadata obtained during a given gesture. The metadata analyzed by the second order gesture recognition engine may also extend to a period of time before and/or after the performance of a given gesture.

With the benefit of the above disclosure, those of skill in the art will recognize a wide variety of additional styles which may be associated with a wide variety of additional gestures, which styles may be recognized on analysis of the metadata associated with a gesture, a time period before the gesture and/or a time period after the gesture.

Style library 640 may store a plurality of rules 642. In embodiments, each gesture may have a different, unique set of rules. Thus, while a given set of metadata may be stylistically significant when performed in conjunction with a first gesture, the same metadata may not be indicative of that style when performed in association with a second gesture. A single gesture may have a wide variety of styles associated therewith. In this instance, style library 640 will store a number of rules 642, one rule for each style that may be associated with a given gesture. Each predefined gesture may include such a set of rules associated therewith.

In further embodiments, a single style may be associated with more than one gesture. Furthermore, a given set of metadata may be indicative of a particular style independent of any associated gesture. In such embodiments, the second order gesture recognition engine 190b may recognize a particular style associated with a user's movement, even though that movement may not be indicative of a specific recognized gesture.

Moreover, it is contemplated that the second order gesture recognition engine 190b may detect one or more styles even where the first order gesture recognition engine determines that the user has failed in performing an attempted gesture. For example, a rule may exist for one or more gestures which indicates that a lot of movement is to be interpreted that the user is putting in a lot of effort to the one or more gestures. Thus, even if the movements do not pass as to establish a particular gesture, the second order gesture recognition engine 190b may recognize the effort exerted by the user and personalize the user's in-game experience by indicating recognition of the user's effort.

Some of the styles which may be covered by rules include but are not limited to:
Grace of movement—where the metadata indicates a user performs movements or transitions between movements with a relatively smooth or constant velocity and/or acceleration;
Effort—for example where the metadata indicates a high degree of movement associated with a given gesture;
Body control—for example where the metadata indicates that a user is able to keep his or her body or portions of his or her body motionless;
Precision of movement—where the metadata indicates that the only motion performed by the user was that required to perform a given gesture;
Efficiency of movement—where the metadata for example indicates that the only motion performed by the user was those body parts required to perform the gesture;
Steady movement—where the metadata indicates a relatively constant velocity of one or more body parts in performing a given gesture;
Slow and steady movement—where the metadata indicates a relatively constant velocity below a threshold value of one or more body parts of a user when performing a given gesture;
Nonchalant, relaxed movement—for example where the metadata indicates low or constant velocity movements in preparing to perform a given gesture;
Flare or dramatic movement—for example where a user has excessive and/or grandiose movement associated with a given gesture.

Referring again to the flowchart of FIG. 11, each rule may have a number of parameters (maximum/minimum position, change in position, etc.) for one or more of the body parts shown in FIG. 4C. For a stored rule, each parameter for each body part 302 through 330 shown in FIG. 4B may store a single value, a range of values, a maximum value, a minimum value or an indication that a parameter for that body part is not relevant to the determination of the style covered by the rule.

In the following description, the different parameters may be indicated by the integer, i (i=1 for the first parameter, i=2 for the second parameter, etc.). The different body parts may be indicated by the integer, j (j=1 for the first body part, j=2 for the second body part, etc.). Thus, R_{i,j} is the stored value or range of values in a rule associated with the i^{th} parameter for the j^{th} body part. M_{i,j} is the measured or derived value or range of values from a user's gesture or motion associated with the i^{th} parameter for the j^{th} body part.

In step 700, when determining whether received metadata satisfies a given rule, the engine 190b initially retrieves the stored rule value R_{i,j} for the first body part (j=1) for the first parameter (i=1). In step 702, the engine 190b compares the received measured metadata value M_{i,j} against the stored rule metadata value R_{i,j}. In step 706, the engine 190b determines whether the current measured metadata value M_{i,j} is equal to or within a predefined range of the rule metadata value for R_{i,j}.

It is understood that while a rule may consist of a group of parameters with given values, one or more of these parameters may be weighted more heavily in determining whether a user's actions satisfy a given style rule. That is, certain parameters for certain body parts may be more indicative of a particular style than others. In embodiments, these parameters for the indicated body parts may be accorded a higher weight in the overall determination of whether the user's movements performed a given style. As such, in step 710, the engine 190b determines whether the rule value R_{i,j} is weighted higher or lower relative to other rule values R_{i,j}. This weight information may be stored with a rule in library 640.

It will seldom, if ever, happen that a given set of measured parameters will match all values in a stored rule. As explained above with respect to gestures, the second order gesture recognition engine 190b may output both a style and a confidence level which corresponds to the likelihood that the user's movement corresponds to that style. This confidence value may be calculated in the same way the confidence value for a given gesture was calculated as described above. In step 712, using the determination of steps 706 and 710, the engine 190b determines a cumulative confidence level as to whether the user's movements amount to the style covered by the rule under consideration. A cumulative confidence level will include the confidence level of all prior trips through the loop plus consideration of the current R_{i,j}.

In step 716, the engine 190b looks at whether there are more body parts, j, for a given parameter, i, that have not been considered for a stored rule. If so, the next body part is considered (j=j+1) in step 718 and the engine 190b returns to step 702 to compare the next measured metadata value M_{i,j} against the stored rule value R_{i,j} for the next body part j.

Alternatively, if in step 716 it is determined that the last body part within the rule for a given parameter has been considered, the engine 190b next determines in step 720 whether there are more parameters to consider in the stored rule. If so, the parameter value i is incremented by one step 724 and the engine 190b returns to step 702 to once again compare the received measured metadata value M_{i,j} against the stored metadata rule value R_{i,j} for the updated parameter value i. Those of skill in the art will appreciate other methods of comparing the measured values M_{i,j} against the stored rule value R_{i,j}. If it is determined in step 720 that there are no more parameters in the stored rule to consider, engine 190b returns the cumulative confidence level in step 728.

Referring again to FIG. 10, once a confidence level has been determined as to whether a given gesture or motion satisfies a given style rule, the second order gesture recognition engine 190b then determines in step 656 whether the cumulative confidence level is above a predetermined threshold for the rule under consideration. The threshold confidence level may be stored in association with the rule under consideration. If the cumulative confidence level is below the threshold, no style is detected (step 660) and no action is taken. On the other hand, if the cumulative confidence level is above the threshold, the user's motion is determined to satisfy the style rule under consideration, and the second order gesture recognition engine 190b personalizes the user experience as explained hereinafter. The second order gesture recognition engine may cease its rule comparisons once a style associated with a gesture or motion is detected. Alternatively, the second order gesture recognition engine may search through all rules to see if more than one style applies to a given gesture or motion.

Those of skill in the art will understand other methods of analyzing the measured parameters to determine whether the parameters conform to a predefined style, for a given gesture or motion. One such additional method is disclosed in U.S. Patent Application Publication No. 2009/0074248, entitled “GESTURE-CONTROLLED INTERFACES FOR SELF-SERVICE MACHINES AND OTHER APPLICATIONS,” which publication is incorporated by reference herein in its entirety.

The detection of a given style may be used within the game or multimedia platform in a variety of ways in order to reward and/or personalize the experience for the user. For example, when the user's avatar is shown to perform the detected gesture, the gesture may further be performed by the avatar with the detected style. Additionally and/or alternatively, the appearance of the avatar may change to reflect the detected style. For example, if the user's gesture is to remain still without moving, if the user is able to perform this action not just to a threshold level, but to a level exhibiting high levels of body control, the user's avatar may become transparent and partially disappear. Given the above disclosure, those of skill in the art would appreciate a wide variety of other in-game audio and/or video effects which may be provided to illustrate the detected style associated with a performed gesture. Moreover, in addition to rendering the avatar in a different manner, the avatar's surrounding within the game may alternatively or additionally be rendered in a different manner to further illustrate the user's style and to further personalize the gaming experience for the user.

Detecting the style of a given user in accordance with present technology is conceptually different than detecting whether a user has performed a given gesture. Performance of a given gesture is typically pass/fail and, if successfully performed, will result in additional points or the user advancing under the game metric. By contrast, the detection of styles is not about whether a user has performed a given gesture but rather how the user has performed the gesture. The present technology may detect a style whether or not the user has successfully performed an underlying gesture and detection of a style does not result in points or advancement of the player under the game metric (although performing a gesture with a detected style may result in points or advancement in further embodiments). Moreover, as indicated above, a given style may be associated with a particular gesture, or it may be detected independent of any particular gesture or across a wide variety of gestures. In general, recognition of individual player styles will personalize and enhance the user experience when playing a game or using a multimedia application.

The foregoing detailed description of the inventive system has been presented for purposes of illustration and description. It is not intended to be exhaustive or to limit the inventive system to the precise form disclosed. Many modifications and variations are possible in light of the above teaching. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

What is claimed:

1. In a system comprising a computing environment coupled to a capture device for capturing user motion, a method of personalizing a user experience in a software application, comprising the steps of:
a) detecting, on a pass/fail basis, whether the user performed a gesture;
b) detecting at least one qualitative aspect, in addition to detecting whether the user performed a gesture, relating to how the user performed the gesture; and
c) providing feedback to the user based on the at least one qualitative aspect detected in step b).

2. The method of claim 1, said step b) comprising the step of comparing parameters obtained in said step a) against a stored set of rules relating to the at least one qualitative aspect.

3. The method of claim 1, said step b) comprising the step of comparing parameters derived from said step a) against a stored set of rules relating to the at least one qualitative aspect.

4. The method of claim 1, said step b) comprising the step of analyzing at least one of:
b1) a maximum and minimum position, relative to the capture device along three axes;
b2) a change in position over time along three axes;
b3) a maximum and minimum velocity along three axes;
b4) a change in velocity over time along three axes;
b5) a maximum and minimum acceleration along three axes;
b6) a change in acceleration over time along three axes; and
b7) facial expression.

5. The method of claim 4, said step b) further comprising the step of analyzing at least one of b1) through b6) for a plurality of different body parts.

6. The method of claim 5, said step b) further comprising the step of comparing the analyzed parameters of at least one of b1) through b7) against a stored set of rules defining styles associated with a given gesture.

7. The method of claim 5, said step b) further comprising the step of analyzing at least one of b1) through b7) from a period of time equal to one of:
b8) a predetermined period of time prior to completion of the gesture;
b9) a length of time required to perform the detected gesture; and
b10) a length of time required to perform the detected gesture plus a predetermined period of time before and/or after the gesture.

8. The method of claim 1, said step b) comprising the step of detecting at least one of the following qualitative aspects associated with the gesture:
b11) a graceful movement associated with the gesture;
b12) an amount of effort exerted in performing the gesture;
b13) body control in performing the gesture;
b14) precision of movement in performing the gesture;
b15) efficiency of movement in performing the gesture;
b16) how steady portions of the user's body remained in performing the gesture;
b17) how relaxed portions of the user's body remained in performing the gesture; and
b18) how dramatic the user's movements were in performing the gesture.

9. The method of claim 1, said step c) comprising the step of altering a portion of the software application presented to the user to personalize what is presented to the user based on the qualitative aspect detected in said step b).

10. In a gaming system comprising a computing environment coupled to a capture device for capturing user motion, a computer-readable storage medium bearing computer-readable instructions that, when executed on a processor, cause the processor to perform a method comprising the steps of:
a) receiving data relating to user motion;
b) determining, on a pass/fail basis, whether the user motion data received in said step a) corresponds to a predefined gesture;
c) determining at least one qualitative aspect, in addition to whether the user motion data received in said step a) corresponds to a predefined gesture, relating to a style with which the user performed the motion in said step a); and
d) providing feedback to the user based on the at least one qualitative aspect detected in step c).

11. The method of claim 10, wherein said step c) may determine at least one qualitative aspect where said step b) determines a user did not perform a predefined gesture.

12. The method of claim 10, wherein said step c) comprises the step of comparing metadata relating to the qualitative aspect of the user motion against a set of rules defining when user motion qualifies as a predefined style.

13. The method of claim 12, wherein said step c) comprises storing a different set of rules for different predefined gestures.

14. The method of claim 12, wherein said step c) comprises storing a single rule that applies across different predefined gestures and/or different user motions.

15. The method of claim 12, wherein said step c) comprises storing rules with predefined parameter values relating to at least one of a position or change in position, a velocity or a change in velocity or an acceleration or change of acceleration of one or more portions of the user's body that are interpreted as a particular style with which the user's motion was performed.

16. The method of claim 12, wherein said step c) comprises storing rules defining when a user's motion is interpreted as one of the following styles:
c1l) a graceful movement associated with the user's motion;
c2) an amount of effort exerted in performing the user's motion;
c3) body control in performing the user's motion;
c4) precision of movement in performing the user's motion;
c5) efficiency of movement in performing the user's motion;
c6) how steady portions of the user's body remained in performing the user's motion;
c7) how relaxed portions of the user's body remained in performing the user's motion; and
c8) how dramatic the user's movements were in performing the user's motion.

17. A gaming system, comprising:
an image capture device for capturing data relating to motion of a user;
a computing environment for receiving image data from the capture device and for hosting a gaming application, the computing environment including,
a first order gesture recognition engine for receiving data relating to the motion of a user, and determining on a pass/fail basis whether the motion of the user qualifies as a predefined gesture,
a second order gesture recognition engine for receiving at least one of the data and information derived from the data, and determining, in addition to a threshold determination of whether the motion of the user qualifies as a predefined gesture, whether the motion of the user includes a stylistic attribute which qualifies as a predefined style associated with the user motion, and
a set of stored rules used by the second order gesture recognition engine, the set of stored rules including definitions of when a predefined set of user motions is to be interpreted as a predefined style; and
an audiovisual device, coupled to the computing environment, for presenting a graphical representation of the user and the user's motion based on information received from the computing environment, the graphical representation being enhanced by showing a user's motion or surroundings with graphics representing a style determined to exist by the second order gesture recognition engine.

18. The gaming system of claim 17, wherein the computing environment causes the audiovisual device to show a user gesture determined to exist by the first order gesture recognition engine, and the gesture is shown with graphics representing a style determined to exist by the second order gesture recognition engine.

19. The gaming system of claim 17, wherein the computing environment causes the audiovisual device to show graphics representing a style associated with a user motion where the first order gesture recognition engine determines the user motion does not qualify as a gesture.

20. The gaming system of claim 17, wherein the second order gesture recognition engine analyzes parameters associated with the user's motion including at least one of a position or change in position, a velocity or a change in velocity and an acceleration or change of acceleration of one or more portions of the user's body and compares those parameters against parameters in the set of stored rules.
